(19) United States
(12) Patent Application Publication
(10) Pub. No.: US 2016/0080106 A1
(43) Pub. Date: Mar. 17, 2016

(54) METHOD FOR ASSIGNING PRS MUTING PATTERNS FOR RSTD MEASUREMENT ACQUISITION

(71) Applicant: QUALCOMM Incorporated, San Diego, CA (US)

(72) Inventors: Ramya Srinivasan, San Jose, CA (US); Guttorm Opshaug, Redwood City, CA (US); Grant Alexander Marshall, Campbell, CA (US); Borislav Ristic, Del Mar, CA (US); Sven Fischer, Nuremberg (DE)

(21) Appl. No.: 14/846,514

(22) Filed: Sep. 4, 2015

Related U.S. Application Data
(60) Provisional application No. 62/051,802, filed on Sep. 17, 2014.
(60) Provisional application No. 62/159,021, filed on May 8, 2015.

(51) Int. Cl. H04K 3/00

(52) U.S. Cl. CPC H04K 3/90; H04K 3/65

(57) ABSTRACT

One or more sequences of binary values may be generated based on a length L and a duty cycle D, wherein duty cycle D denotes a percentage of a number of bits of value one in length L. Then, based on an identity of a cell, a sequence may be selected for use by a base station in muting its transmission of a positioning signal. The sequence which is selected may be used directly in muting with no change therein, or may be elongated followed by use of an elongated sequence in muting. When specific occasions are muted in the positioning signal, a mobile device may measure times of arrival of other positioning signals that are not muted. Two such measurements of arrival times may be used to compute a difference there between, for use as a difference measurement in a procedure to determine a location of the mobile device.

### CROSS-REFERENCE TO PROVISIONAL APPLICATIONS

This application claims the benefit of and priority to U.S. Provisional Application No. 62/051,802 filed on Sep. 17, 2014 and entitled “METHOD FOR ASSIGNING PRS MUTING PATTERNS FOR RSTD MEASUREMENT ACQUISITION”, which is incorporated herein by reference in its entirety.

This application claims the benefit of and priority to U.S. Provisional Application No. 62/159,021 filed on May 8, 2015 and entitled “METHOD FOR ASSIGNING PRS MUTING PATTERNS FOR RSTD MEASUREMENT ACQUISITION”, which is incorporated herein by reference in its entirety.

### BACKGROUND

This patent application relates to devices and methods for muting a positioning reference signal (PRS) transmitted by a base station (BS) of a cellular network, for use in timing measurements by user equipment (UE). In a cellular network, a user equipment (UE) such as a smartphone (or other wireless device) is wirelessly connected to a base station (BS) that serves a geographic area, also referred to as a cell.

Long Term Evolution (LTE), defined in a standard known as 3^{rd} Generation Partnership Project (3GPP), describes measurement by a mobile device, of a difference in times of arrival, of signals from two base stations. To enable detection of signals from multiple base stations, a signal in LTE is dedicated to positioning, known as a positioning reference signal (PRS). PRS signals from different base stations can overlap, resulting in interference at the mobile device. To reduce interference, one or more PRS signals can be muted at one or more specific times (called “positioning occasions”), in a sequence (called “muting sequence”). The muting sequence may be represented as a bit string, with each bit having a binary value, namely 0 or 1, with 0 for muting transmission of the PRS signal and 1 for transmitting the PRS signal unmuted.

### SUMMARY

In several aspects of described embodiments, one or more sequences of binary values (also called patterns) may, for example, be automatically generated to have a specific length L and a specific duty cycle D, wherein duty cycle D denotes a percentage of a number of bits of a predetermined binary value, e.g. value 1 in length L. Then, based on an identity of a cell (e.g. PCI), a particular sequence of binary values may be selected from among one or more generated sequences. Each particular sequence may, for example, be directly used by a corresponding device (e.g. a base station) in muting its transmission of a positioning signal, such as a positioning reference signal (PRS), at specific times indicated by a predetermined binary value (e.g. binary value 0) in the particular sequence of the corresponding device. Thus, in these embodiments (also called “direct-usage embodiments”), two or more such devices use their respective particular sequences in a coordinated operation, to transmit respective positioning signals, synchronously relative to one another.

In direct-usage embodiments, the particular sequence which is used as the muting sequence has a length identical to the specific length L used as input (for initial sequence generation, as described in the first sentence above). In other embodiments (also called “indirect-usage embodiments”), a particular sequence (also called “generator muting sequence”) of the specific length L and which has been determined based on cell identity as described above, is used indirectly, by elongation thereof to generate a muting sequence of a larger length LL that is less than a predetermined maximum Lmax (e.g. by enumeration of its permutations, and/or concatenation of re-shuffled and/or reversed values). Depending on the embodiment, a muting sequence used by a device may be generated internally by the device itself (“positioning device”) based on L and D, or generated in an OA&M computer and provided to the positioning device.

During muting, at the specific times when specific portions are muted in such a signal (e.g. specific positioning occasions), another device (“measurement device”, e.g. a user equipment (UE)) measures time of arrival of other signal(s), e.g. positioning signal(s) transmitted from other positioning devices which are not muted at these times (e.g. in the specific positioning occasions). Two measurements of arrival times of positioning signals from two positioning devices by the measurement device may, for example, be used to compute a difference therebetween, which may in turn be used as a Reference Signal Time Difference (RSTD) measurement, in a normal manner e.g. to determine a location of the UE. The number N of sequences that are initially generated may, for example, be based on a length L (e.g. 8) of the generated sequences and based on a duty cycle D (e.g. 50%). In one illustrative example, number N=L!/[(L*D)!×(L*(100−D))!]. Length L and duty cycle D can each have various predetermined values that depend on the embodiment. In some embodiments, a possible range for the value of L is 2, 4, 8 and 16, with 8 being preferred. In such embodiments, a possible range for the value of D is 30% to 70%, preferably 40% to 60%, with a most preferred value of D being 50%. Hence, in several preferred embodiments L=8 and D=50%, and based thereon N is 70.

In certain embodiments, an OA&M computer may, for example, use a predetermined value of L (e.g. 8) and a predetermined value of D (e.g. 50%) to generate and store in a table, N sequences of bits (of a binary value), and may, for example, use the PCI of a cell to determine an index in the range 1-N, and may, for example, use the index to lookup the table and retrieve a particular sequence from among the generated sequences for use directly as a muting sequence, or for use indirectly in creating an elongated sequence that is then used as the muting sequence. The OA&M computer may, for example, transmit the muting sequence to a positioning device, such as a base station identified by the PCI that may, for example, mute a positioning signal transmitted therefrom, such as a positioning reference signal. In other embodiments, the OA&M computer may, for example, transmit a predetermined value of L (e.g. 8) and a predetermined value of D (e.g. 50%), to multiple base stations. Each base station may, for example, use its own PCI to determine an index, and may, for example, use the index with the received values of L, D to generate a particular sequence (also called pattern) using a common procedure. Multiple such procedure-generated sequences may be used (directly, or indirectly after creation of corresponding elongated sequences) by each of multiple base stations, which are coordinated by the OA&M computer, in muting their respective positioning signals, for example, to transmit multiple positioning reference signals synchronously relative to one another.

In embodiments wherein different positioning occasions (e.g. odd and even positioning occasions) have different properties of transmission (e.g. due to use by a positioning device, of different transmitters in transmitting a positioning signal, in different positioning occasions), a particular sequence which is generated based on cell identity as described above may be used to obtain an elongated sequence of larger length LL which is greater than the specific length L but less than the predetermined maximum Lmax (for example, by permutation of elements (e.g. binary values) of the particular sequence, or by repetition of elements (e.g. binary values) of the particular sequence in reverse order, or by each element (e.g. binary value) of the particular sequence being repeated in order of occurrence in the particular sequence).

Those of skill in the art should understand that, in certain instances and/or at certain times, a sequence or pattern of binary values may be represented by one or more other forms of data or information. By way some non-limiting examples, a sequence of binary values may be represented by an equivalent octal based value, decimal based value, hexadecimal based value, etc. In other examples, in certain implementations, some other indicative set of data representing one or more symbols, all or part of a script or formula that may be understood to represent or generate a particular binary sequence. Hence, as used herein, the term “binary values” is intended to include one or more forms of data/information that may represent in some manner such binary values.

It is to be understood that several other aspects of the invention will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF DRAWINGS

FIG. 1A illustrates, in a high-level diagram, transmission of muting characteristics by an OA&M server 100 to base stations 101A . . . 101I . . . 101J . . . 101N, and use of the muting characteristics in transmission of PRS signals to user equipment 102 for use in measurements of arrival times, in several aspects of described embodiments.

FIG. 1B illustrates, in a flow chart, obtaining duty cycle and length, and base station identities and use thereof in determination of one or more muting characteristics that are transmitted to at least a base station for use in muting the transmission of a positioning signal, in several aspects of described embodiments.

FIG. 2A illustrates, in a high-level diagram, transmission of length and/or duty cycle as the muting characteristics by an OA&M server 100 to base stations 101A . . . 101I . . . 101J . . . 101N, and use of the muting characteristics in transmission of PRS signals to user equipment 102 for use in measurements of arrival times, in several aspects of described embodiments.

FIG. 2B illustrates, in a flow chart, obtaining duty cycle and length and transmission of the duty cycle and length as muting characteristics by an OA&M server 100 to base stations 101A . . . 101I . . . 101J . . . 101N, in certain aspects of described embodiments.

FIG. 2C illustrates, in another flow chart, use of duty cycle and length by each base station 101I with its own identity, to generate a muting sequence and use thereof to transmit a positioning signal, in certain aspects of described embodiments.

FIG. 3A illustrates, in a flow chart, acts performed by a simulator 310 to identify a duty cycle and a length, and acts performed by a muting sequence generator 320 to use the duty cycle and length with base station identities, and generate muting sequences, in certain aspects of described embodiments.

FIG. 3B illustrates, acts performed by an OA&M server 340, in certain aspects of described embodiments.

FIG. 3C illustrates, acts performed by one or more base stations 350, in certain aspects of described embodiments.

FIG. 4A illustrates, in a low-level flow chart, a common procedure performed by each base station, to generate a muting sequence in some embodiments.

FIG. 4B illustrates, in a flow chart, a method that includes acts performed by a muting sequence generator 450, to create a muting sequence in some embodiments.

FIG. 4C illustrates, in another flow chart, a method that may additionally be performed by muting sequence generator 450, for example between acts 452 and 453 in FIG. 4B.

FIG. 5A illustrates, in a high-level block diagram, components of computer 500 that may be used as a location server, in some illustrative embodiments.

FIG. 5B illustrates, in a high-level block diagram, components of a computer 510 that may be used in a base station, in some illustrative embodiments.

FIG. 6 illustrates, in a flow chart, computer(s) 600 using identities of cells (or base stations 604, 606, and 608) to automatically generate sequences, based on a common length and a common duty cycle, and base stations 604, 606, and 608 transmitting positioning signals synchronously relative to one another, in an operation coordinated by computer(s) 600, to determine a position of mobile device 610, in some embodiments.

### DETAILED DESCRIPTION

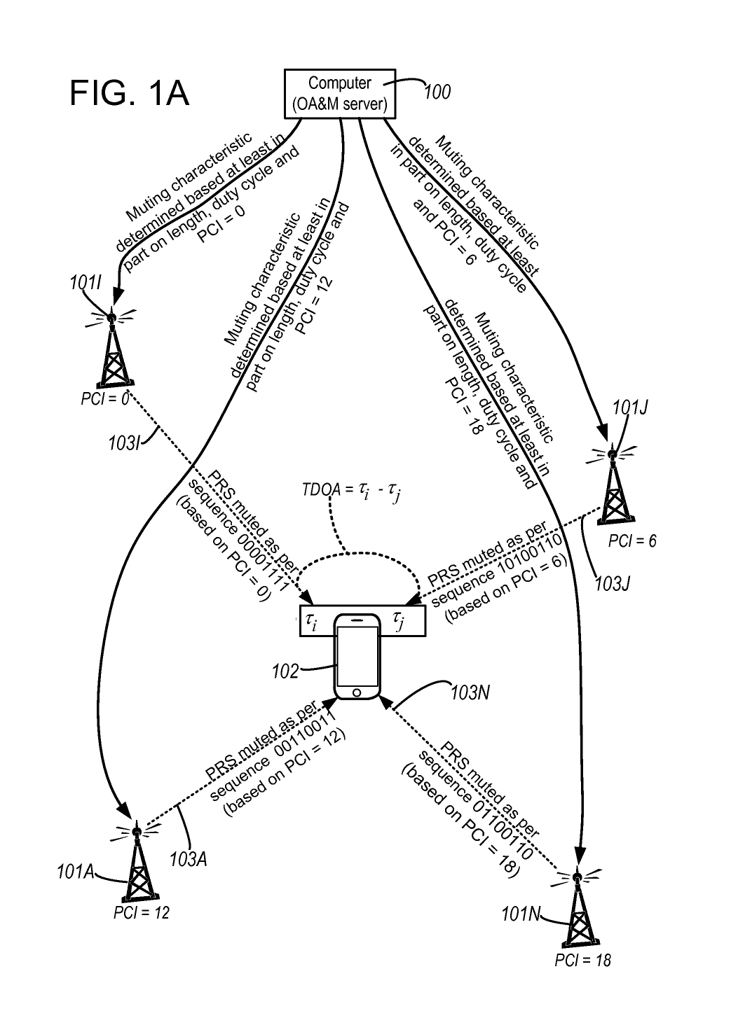

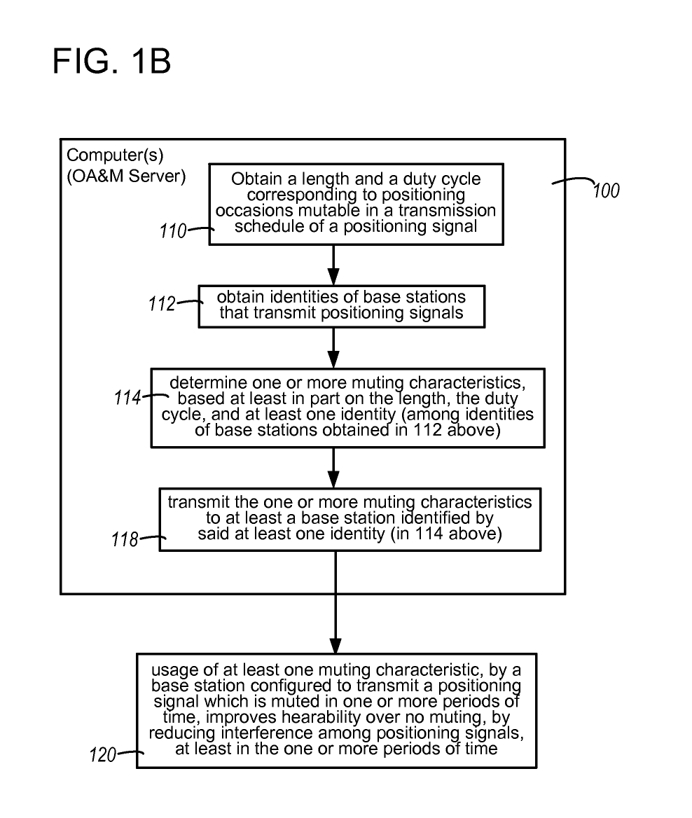

Some embodiments implement one or more acts in a method of coordinating transmission of positioning signals by use of one or more computers (e.g. computer 100) as described below. The positioning signals, which are having their transmission coordinated may be, for example, positioning reference signals that are transmitted synchronously relative to one another, in accordance with the Long Term Evolution (LTE) standard, as defined in 3^{rd} Generation Partnership Project (3GPP), such as the PRS signals 103A . . . 103I . . . 103J . . . 103N in FIG. 1A which are transmitted by corresponding base stations 101A . . . 101I . . . 101J . . . 101N for use in measurement of times of arrivals thereof at mobile devices, such as user equipment 102 (FIG. 1A).

Computer(s) 100 obtains, in an act 110 (FIG. 1B), a length and a duty cycle that correspond to positioning occasions which are mutable, in a transmission schedule of a positioning signal 101I. In the transmission schedule, the positioning occasions may occur periodically with a periodicity T_{PRS}. The period T_{PRS} is defined in 3GPP TS 36.211, and can be, for example, 160, 320, 640, or 1280 subframes (or milli-seconds), depending on the implementation. A PRS signal 103I may be transmitted in a N_{PRS} number of positioning subframes that occur consecutively relative to one another, and are termed as “positioning occasions”. The number N_{PRS} can be 1, 2, 4 or 6 subframes, each subframe having a duration of 1 millisecond, in a radio frame of 10 milliseconds. One first subframe in one group of N_{PRS} subframes may be separated from another first subframe in a successive group of N_{PRS} subframes, by T_{PRS} subframes in the transmission schedule.

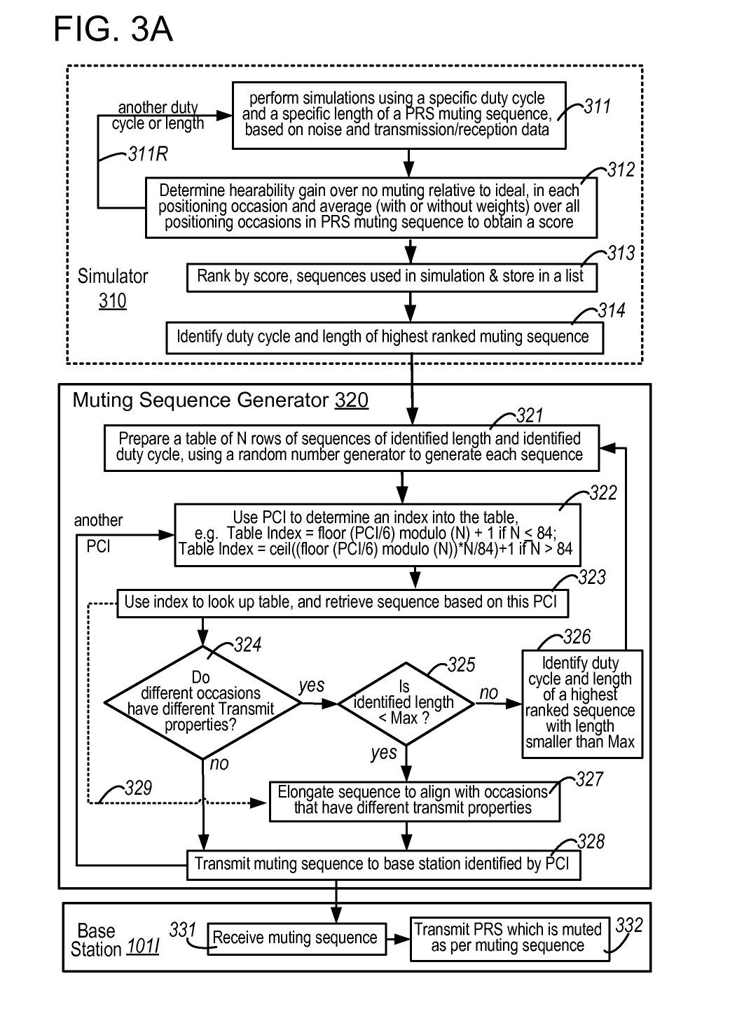

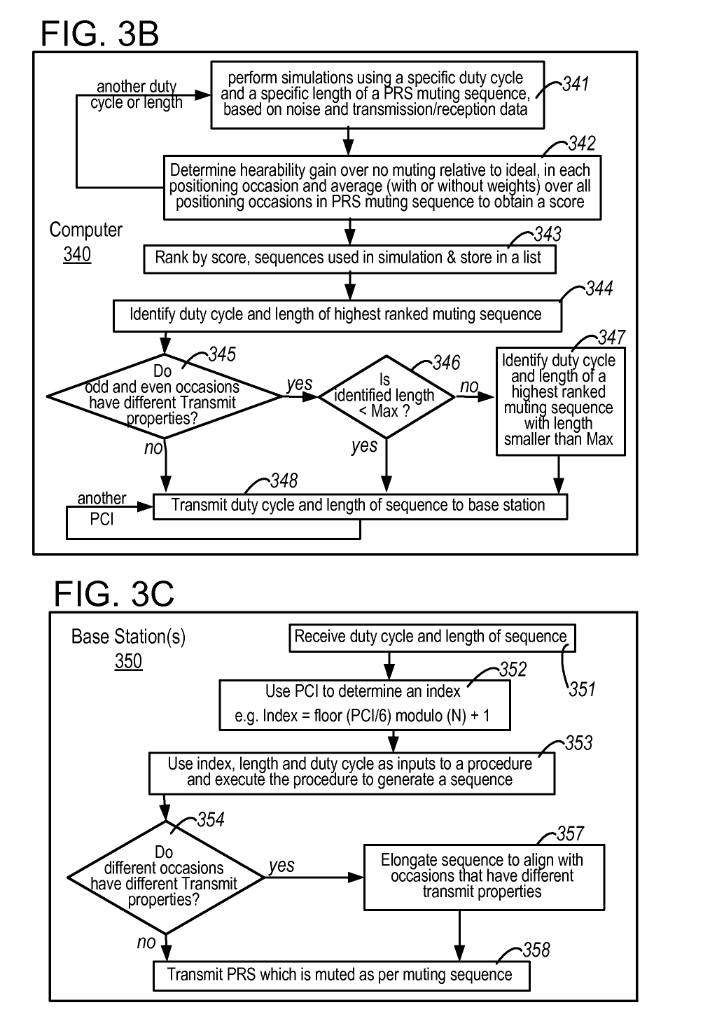

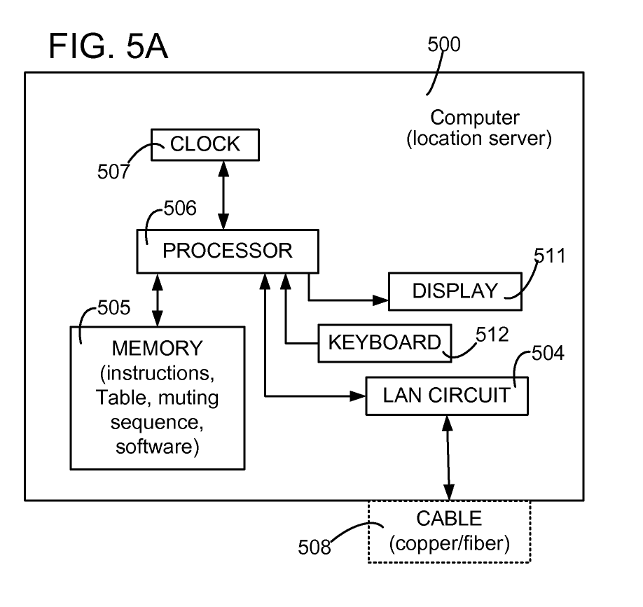

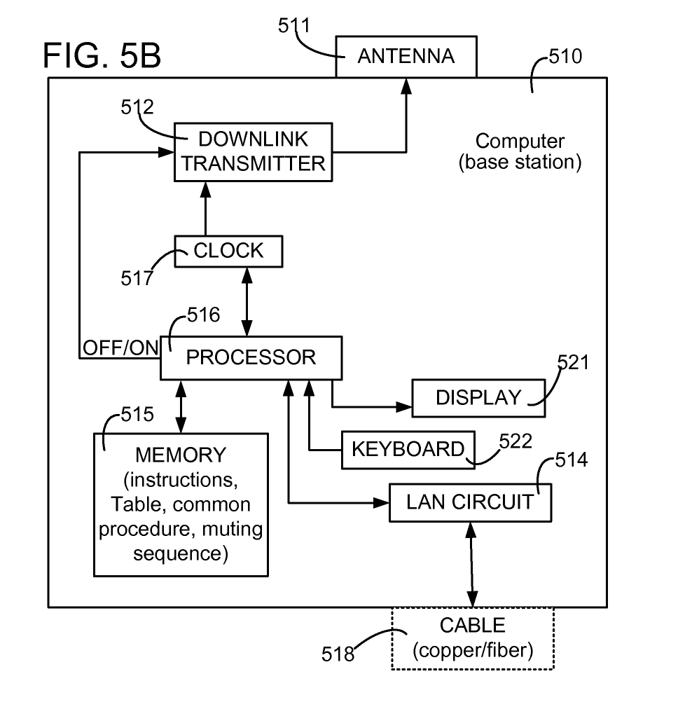

The length obtained by computer(s) 100 in act 110 may indicate, in certain embodiments, a number of positioning occasions that can be muted in a positioning signal (e.g. 8 positioning occasions in positioning signal 101I). The duty cycle may indicate, in such embodiments, a percentage of positioning occasions that are muted in a positioning signal (e.g. 25% duty cycle may indicate that 2 positioning occasions are muted and 6 positioning occasions are unmuted, in a total of 8 positioning occasions). Depending on the embodiment, the length and the duty cycle may be obtained in different ways, for example, obtained in user input received from a keyboard 512 (FIG. 5A), or obtained from a simulator 310 (FIG. 3A).

Additionally, in act 112 (FIG. 1B), computer(s) 100 obtains identities of base stations (base stations 101A . . . 101I . . . 101J . . . 101N in FIG. 1A) which are available to transmit the plurality of positioning signals (e.g. PRS signals 103A . . . 103I . . . 103J . . . 103N). An identity of a base station 101I which is obtained in act 112 may be, for example, a physical cell identity (PCI) which may be used in some embodiments to initialize a seed for generating complex-valued QPSK modulation symbols that are transmitted in a positioning signal. Examples of identities of base stations 101A . . . 101I . . . 101J . . . 101N are PCI=12, PCI=0, PCI=6 and PCI=18 as shown in FIG. 1A. The above-described acts 110 and 112 may be performed in any order relative to one another, in different embodiments.

In transmitting positioning signals, tones in a signal may be re-used by shifting the tones in frequency, as determined by v_—shift=mod (PCI, 6), wherein the frequency re-use factor is 6. In the example shown in FIG. 1A, each of base stations 101A . . . 101I . . . 101J . . . 101N has a common mod (PCI, 6) value, and hence these base stations synchronously transmit tones which collide, causing interference. To overcome or reduce such interference, one or more base station(s) 101I may be instructed to mute transmission of tones of respective positioning signal(s) 103I in certain positioning occasions. One or more positioning occasions, in which a base station 101I is to mute transmission of a positioning signal, may be specifically associated with and identified for base station 101I, by use of one or more muting characteristic(s). The muting characteristic(s) may be determined by computer(s) 100 in an act 114 (FIG. 1B), based at least in part on the length, the duty cycle and at least one identity (e.g. identity of base station 101I) which were received in acts 110 and 112 (described above). Thereafter, in an act 115 (FIG. 1B), computer(s) 100 transmit the one or more muting characteristics at least to a base station identified by said at least one identity (which was used in act 114, to determine one or more muting characteristics).

Usage by a base station 101I, of the one or more muting characteristics to transmit a positioning signal (e.g. PRS signal 103I in FIG. 1A) which is muted in one or more periods of time (e.g. one or more positioning occasions) improves hearability over no muting, by reducing interference among a plurality of positioning signals (e.g. PRS signals 103A . . . 103I . . . 103J . . . 103N), at least in the one or more periods of time. Depending on the embodiment, a base station (such as base station 101I) although available, may be muted in all positioning occasions in a corresponding positioning signal transmitted therefrom (e.g. PRS signal 103I).

The muting characteristic(s) which may be transmitted in act 118 depend on the embodiment. In different embodiments, the muting characteristics may be any one or more of the following alone or in any combination with one another: (1) software executable to generate one or more sequences, (2) a set of sequences, (3) a specific sequence, or (4) length and/or duty cycle useable to generate a sequence, as described below. A sequence (e.g. the 8-bit sequence 00001111) which is identified by use of muting characteristics may be used directly (or indirectly, after elongation) to mute a positioning signal in one or more periods (e.g. one or more positioning occasions).

Elongation of a sequence may be performed in a predetermined way, to ensure that un-muted occasions are distributed equally in a transmission schedule, among odd positioning occasions and even positioning occasions, in situations wherein two corresponding transmitters are used by a base station, to respectively transmit a positioning signal in the just-described two types of positioning occasions. In one example described in detail below, values (which may be binary, octal, hexadecimal, etc.) of a specific sequence are repeated in reverse order, to obtain a reversed sequence followed by concatenating the specific sequence with the reversed sequence, to obtain an elongated sequence. As another example, each value (which may be binary, octal, hexadecimal, etc.) in a specific sequence may be repeated, in an order of occurrence in the specific sequence, to obtain the elongated sequence. Other examples of elongation may obtain and use a permutation of a sequence, as described in detail below.

In certain embodiments (“first embodiments”), the one or more muting characteristics comprise a software (which may include a PCI-specific formula, e.g. mod (PCI, 6)), the determining in act 114 identifies the software from among one or more softwares, and the software is transmitted in act 118 to a base station (e.g. base station 101I). Execution of at least the software by the base station of said at least one identity (which was used in act 114), may generate a specific sequence to be used in muting, and/or may generate a positioning signal which is ready for transmission and already including muting (e.g. by silence) in one or more periods (e.g. one or more positioning occasions).

Depending on the embodiment, computer(s) 100 may transmit different softwares to different base stations (e.g. base stations 101A . . . 101I . . . 101J . . . 101N), or transmit a common software to the just-described different base stations. Execution of such software (which may be different or common, depending on the embodiment) by the different base stations generates different sequences that identify different period(s) to be muted in the corresponding positioning signals (e.g. PRS signals 103A . . . 103I . . . 103J . . . 103N).

In illustrative embodiments, a common software is transmitted in act 118 to different base stations (e.g. base stations 101A . . . 101I . . . 101J . . . 101N), and execution of the common software by each base station 101I with an identity thereof (e.g. PCI=0) as an input, generates a sequence specific thereto. In other embodiments, different softwares are executed by the different base stations, to generate different sequences. The generated sequence(s) identify one or more periods (e.g. one or more positioning occasions) that may be muted in the positioning signal (e.g. PRS signal 103I) transmitted by the base station (e.g. base station 101I). For example, a bit of a predetermined value in a specific sequence may directly identify a specific period of muting (e.g. a specific positioning occasion), among one or more periods of time (e.g. among one or more positioning occasions).

In some embodiments (“second embodiments”), the one or more muting characteristics comprise a set of sequences, the determining in act 114 generates at least the set of sequences (e.g. N sequences) using N identities of base stations 101A . . . 101I . . . 101J . . . 101N (including said at least one identity). In such embodiments, the transmitting in act 118 transmits the set of sequences (e.g. N sequences) in a broadcast manner to all the N base stations, e.g. to base stations 101A . . . 101I . . . 101J . . . 101N including the base station 101I identified by said at least one identity (which was used in act 114). Accordingly, the same N sequences are transmitted in act 118 to each of the N different base stations (e.g. base stations 101A . . . 101I . . . 101J . . . 101N). Each base station (e.g. base station 101I) in turn receives all the N sequences. A specific sequence among the N sequences is identifiable by use of an identity of a base station, e.g. a PCI of value k of base station 101I may be used as an index into a table that contains the N sequences, to identify a kth row of the table, and retrieve the specific sequence (from the kth row).

In several embodiments (“third embodiments”), the one or more muting characteristics comprise a specific sequence (e.g. the 8-bit sequence 00001111), the determining in act 114 generates a set of sequences (e.g. N sequences) including the specific sequence, and identifies the specific sequence from among the set of sequences based at least partially on an identity of the base station (e.g. base station 101I with a PCI of value k, as described in the previous paragraph, above). Thereafter, the specific sequence is transmitted in act 118 to a base station (e.g. base station 101I). In such embodiments, act 118 may be repeated multiple times (e.g. N times), once for each base station to transmit thereto a corresponding sequence (e.g. a specific sequence, selected from among the N sequences). Accordingly, in such embodiments, a base station 101I receives a specific sequence corresponding thereto, and no other sequence.

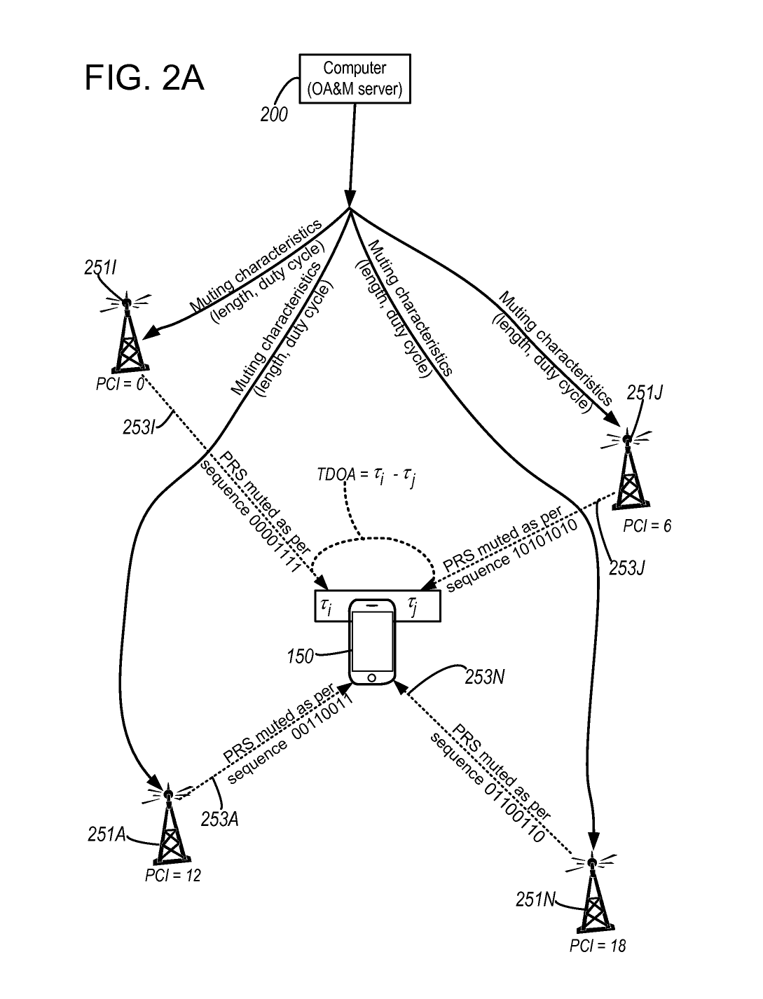

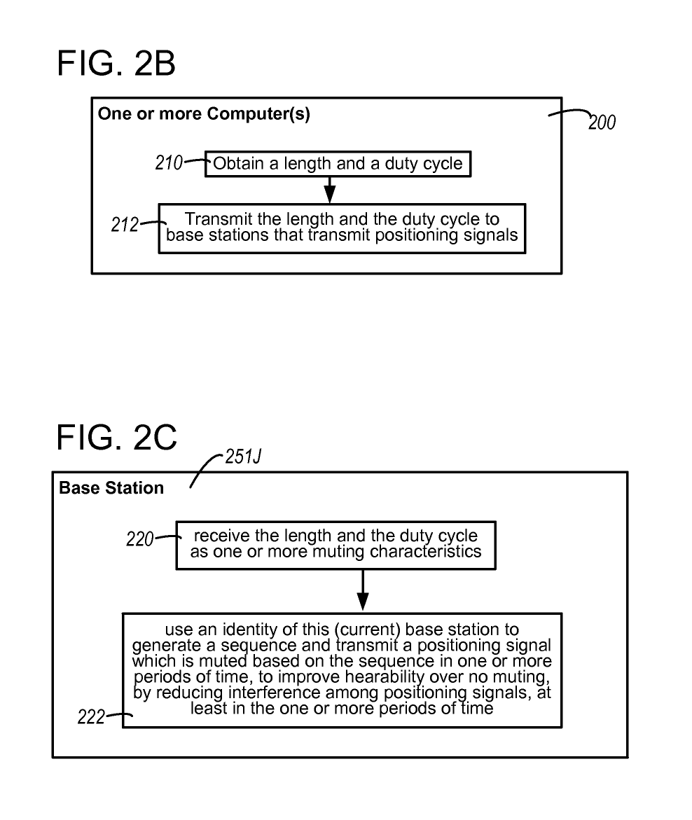

In certain embodiments (“fourth embodiments”), the one or more muting characteristics comprise length and duty cycle, which are obtained by computer 200 in an act 210 (FIG. 2B) and thereafter transmitted in an act 212 to different base stations (e.g. base stations 251A . . . 251I . . . 251J . . . 251N in FIG. 2A). Thus, in an act 220 (FIG. 2C), each base station 251J receives the length and the duty cycle as one or more muting characteristics, in act 220. Thereafter, in an act 222, each base station 251J uses an identity thereof (e.g. PCI=6) as an input (in addition to the length and duty cycle as inputs), to generate a specific sequence, and thereafter transmit a positioning signal based on the specific sequence, which as noted above, improves hearability over no muting, by reducing interference among a plurality of positioning signals (e.g. PRS signals 253A . . . 253I . . . 253J . . . 253N in FIG. 2A), at least in the one or more periods of time. In some fourth embodiments, each base station 251J generates N sequences as described above, followed by use of its identity e.g. a PCI of value k of base station 251I as an index into a table that contains the N sequences, to retrieve a specific sequence, also as described above. In other fourth embodiments, each base station 251J may generate its own specific sequence, without generation of any other sequence. Moreover, depending on the embodiment, a sequence generated by base station 251I may be elongated, and the elongated sequence used in muting, also as described above.

In several aspects of described embodiments, one or more processor(s) in a computer is/are configured to operate as a simulator 310 by performing one or more of acts 311-314 (FIG. 3A) individually or in any combination thereof, e.g. by executing instructions of software stored in a memory (see memory 505 in computer 500 in FIG. 5A). Specifically, in certain embodiments, the processor(s) (such as processor(s) 506 in computer 500 in FIG. 5A) perform simulations in an act 311 using a specific duty cycle D, and a specific length L of a muting sequence, based on data related to noise and transmission/reception of signals. Such data may be obtained from one or more live base stations, for use in the simulations.

During a simulation performed in act 311 (FIG. 3A), duty cycle D as a percentage and length L are used, by processor(s) (e.g. processors 506 in FIG. 5A), to generate N sequences of binary values, wherein N=L!/[(L*D)!×(L*(100−D))!], with exclamation mark “!” denoting factorial. All N generated sequences have a common duty cycle D and a common length L. Each generated sequence is used in act 311 to simulate muting of transmission of a positioning reference signal by a specific base station, while hearability of other base stations (that transmit PRS muted with other generated sequences) at a user equipment (UE) is determined. Gain in hearability at the UE, over no muting relative to ideal, is used by processor(s) in act 312 in FIG. 3A (and in act 342 in FIG. 3B), to determine a score.

For example, if a UE can hear 4 base stations with muting and 3 base stations without muting, a gain in hearability is 4−3=1 under normal conditions. In this example, under ideal conditions (i.e. no PRS interference), if the same UE can hear 6 base stations with muting and 3 base stations without muting, the gain is 6−3=3 under ideal conditions. Hence, in such embodiments, score is computed as a ratio of gain under normal conditions to gain under ideal conditions, in this example score is 1/3, or 0.33.

Score determination in act 312 (FIG. 3A) is followed by the processor(s) (e.g. processors 506 in FIG. 5A) repeating simulations in act 311, e.g. as illustrated by branch 311R, for different combinations of values of duty cycle D, and length L. A possible range for the value of L is 2, 4, 8 and 16, and a possible range for the value of D is 30% to 70%. Each combination of a specific value L in its possible range and a specific value D in its possible range (in increments of 10%) is used as input to act 311, to perform simulations as noted above. These two inputs to act 311 may be received by the processors (e.g. processors 506 in FIG. 5A) via a keyboard (e.g. see keyboard 512 in FIG. 5A), based on a user interface displayed on a display (e.g. see display 511 in FIG. 5A).

After muting with sequences generated by use of multiple combinations of values of L and D has been simulated, by repeated performance of acts 311 and 312, the processor(s) (e.g. processors 506 in computer 500 in FIG. 5A) perform an act 313 in FIG. 3A (and an act 343 in FIG. 3B) that ranks by score, the generated sequences used in simulation, and stores them in a list, in non-transitory memory (e.g. memory 505 in FIG. 5A). Then, in an act 314 in FIG. 3A (and an act 344 in FIG. 3B), processor(s) 506 identify a duty cycle and a length, of the highest ranked sequence in the list. The specific duty cycle and length that are identified in act 314 depends on simulations performed in act 311 in FIG. 3A (and in act 341 in FIG. 3B), and score computation performed in act 312 in FIG. 1B (and in act 342 in FIG. 3B), which may be performed differently in different embodiments. In preferred embodiments of act 314, length L is identified as the specific value 8 and duty cycle D is identified as a specific value in the range 40% to 60%, with a most preferred value of D being identified as 50%. As noted above, a possible range for the value of L is 2, 4, 8 and 16, and a possible range for the value of D is 30% to 70%.

In certain aspects of described embodiments, one or more processor(s) (e.g. processors 506 in FIG. 5A) may be alternatively or additionally configured to operate as a muting sequence generator 320 by performing one or more of acts 321-328 (FIG. 3A) individually or in any combination thereof, e.g. by executing instructions of software stored in a memory (e.g. memory 505 in FIG. 5A). Specifically, in an act 321, processor(s) 506 prepare(s) in memory 505 (FIG. 5A) a table of N rows of sequences of binary values, by enumeration of all sequences having the specific length L and duty cycle D, thereby to obtain N generated sequences. As noted above, the number N=L!/[(L*D)!×(L*(100−D))!]. In some preferred embodiments L=8 and D=50%, and based thereon N is 70. Hence, in such embodiments, a table (also called “binary sequence table”) with N=70 rows is prepared and stored in memory 505 (FIG. 5A), with each row containing a different sequence of 8 bits, wherein 4 bits have binary value 1 (and remaining 4 bits have binary value 0). A specific order, in which these enumerated sequences are stored in the sequence table, depends on how the specific binary values in these sequences are generated by enumeration, which can be done differently in different embodiments.

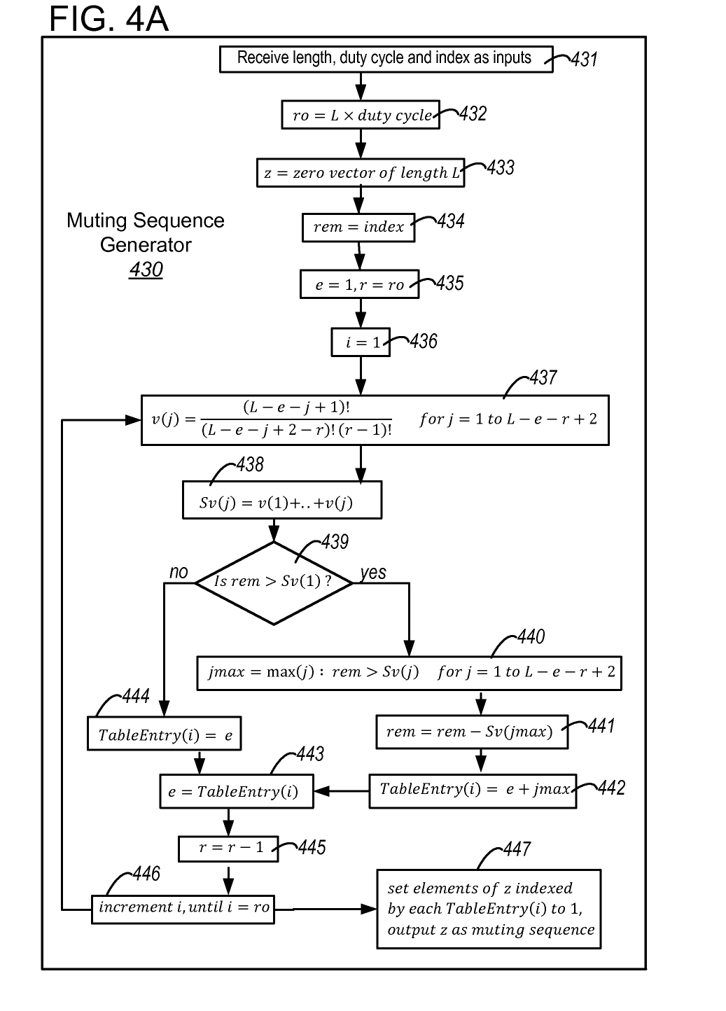

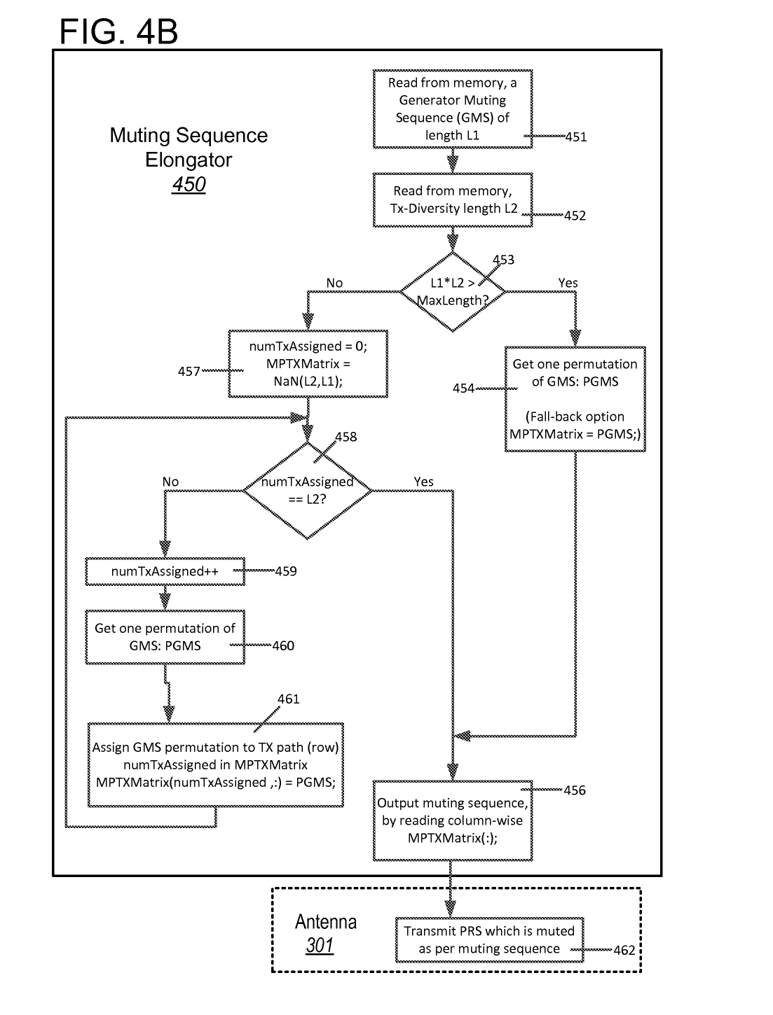

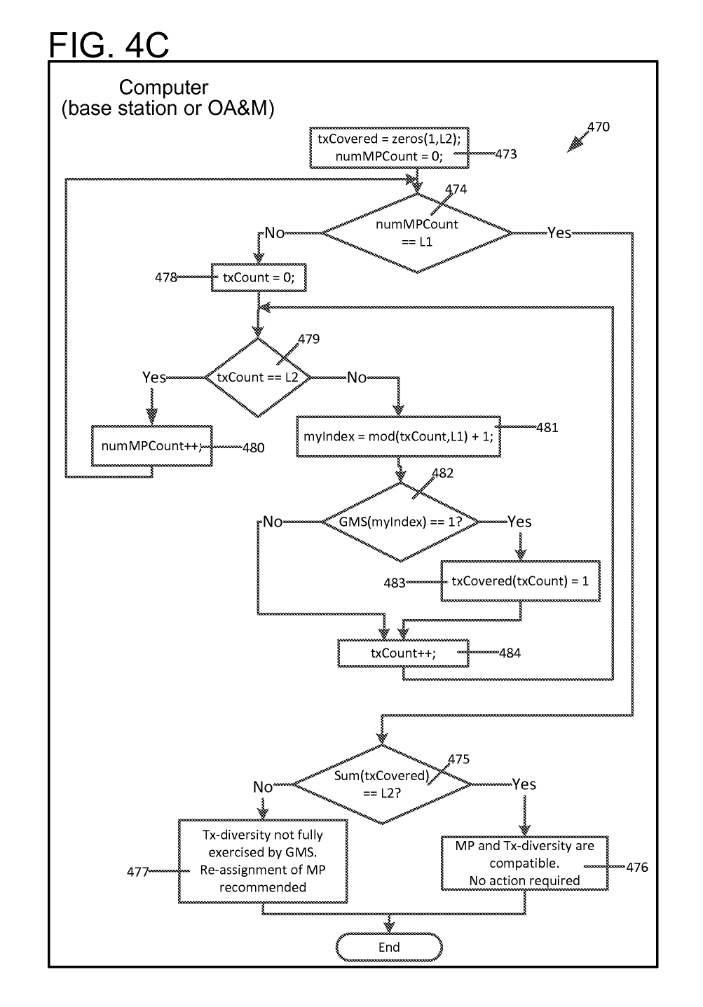

Subsequently, in an act 322, processor(s) 506 use an identifier of a base station, e.g. a PCI of a cell, to determine an index into the table. In some embodiments, table index is computed in act 122 as follows, Table Index=floor (PCI/6) modulo (N)+1 if N is less than or equal to 84 and Table Index=ceil ((floor (PCI/6) modulo (N))*N/84)+1 if N is greater than 84. For example, if N is 70 and if PCI is 13, floor (PCI/6) is computed in act 122 as the integer value 2 (rounding down value 2.17), and the table index is 2 modulo (70)+1, which is 2+1, or 3. Subsequently, in act 323 (FIG. 3A), processor(s) 506 use the table index (e.g. value 3) to look up the binary sequence table, and retrieve a binary sequence (e.g. vector z of binary values, retrieved in act 447 in FIG. 4A) for muting of a PRS signal by the base station identified by this PCI.

In some embodiments, after act 323 (FIG. 3A), processor(s) 506 perform an act 324 to check if positioning occasions in a PRS signal that is to be muted with a sequence retrieved in act 323 (“generated sequence”, or “generator muting sequence”), have transmit properties that are different at different locations in the PRS signal (e.g. positioning occasions that are odd and even relative to one another in an order defined in the PRS signal). Transmit properties of different occasions can be different, for example, if different transmitters are used by a base station to transmit the PRS signal. Specifically, a first transmitter T×0 may be used by a base station for transmitting a wireless signal (including the PRS signal) in odd occasions, and a second transmitter T×1 may be used by the same base station for transmitting the wireless signal in even occasions. In act 324, if the answer is no, then processor(s) 506 go to act 328 to transmit the generated sequence to the base station identified by the PCI, for use therein as a muting sequence.

If the answer in act 324 is yes, then processor(s) 506 perform an act 325 to check if the specific length L of the generated sequence (e.g. identified as per act 314) is less than a predetermined maximum (e.g. Lmax of 16). If the answer in act 325 is yes, in act 327, the generated sequence (of length L) that is retrieved in act 323 is used to obtain an elongated sequence of larger length LL to be used in muting (in indirect-usage embodiments). The generated sequence of length L may be elongated in act 327 to align with occasions that have different transmit properties in several different ways, depending on the embodiment. For example, the generated sequence may be used in some embodiments of act 327 to enumerate permutations in rows of a matrix, followed by reading out columns of the matrix, as shown in FIG. 4B (described below).

Other embodiments of act 327 in which transmit diversity is 2 may: (1) repeat the generated sequence in reverse order, or (2) repeat each element (e.g. binary value) in the generated sequence. In a first embodiment of act 327 when transmit diversity is 2, if the generated sequence is 8 bits long, with value ABCDEFGH (wherein each of A, B, C, D, E, F, G, H has a specific binary value, namely 0 or 1) this generated sequence is changed in act 327 to ABCDEFGHHGFEDCBA to obtain a particular sequence (which is to be used in muting). In a second embodiment of act 327 when transmit diversity is 2, if the generated sequence has the value ABCDEFGH, this generated sequence is changed in act 327 to AABBCCDDEEFFGGHH to obtain a particular sequence (to be used in muting/unmuting transmission of a PRS signal). As to which of these two ways is used when transmit diversity is 2, to obtain an elongated sequence from a generated sequence, depends on the specific implementation of act 327.

In act 325 if the specific length L is at the predetermined maximum (e.g. Lmax of 16), then act 326 is performed wherein processor(s) 506 identify in the list (generated in act 313), a highest ranked sequence with its length smaller than the predetermined maximum Lmax, and based thereon identify a new combination of duty cycle and length. The new combination of duty cycle and length is used in act 321 (described above), followed by acts 322 and 323, in turn followed by act 327. A new combination of duty cycle and length may be obtained in some embodiments by performing acts 324-326 before act 321 (instead of after act 323), and in such embodiments act 327 may be performed after act 323 as shown by arrow 329. Eventually, in act 328 that is performed after act 327, processor(s) 506 transmit the particular sequence obtained in act 327 to the base station identified by the PCI, for use therein as the muting sequence. Note that act 328 is also performed by processor(s) 506 when the answer is no in act 324 (described above). After performing act 328 for one base station, processor(s) 506 return to act 322 with a different PCI, to retrieve a sequence for use by another base station (with or without repetition in act 327, which depends on transmit properties as per act 324).

Transmission of muting sequences by a computer 100 (which is programmed as described above in reference to computer 500) is shown in FIG. 1A in one illustrative embodiment. In FIG. 1A, base stations 101A, 101I, 101J and 101N have PCIs of values 0, 6, 12 and 18, all of which are divisible by 6, and hence PRS signals transmitted by these base stations contain identical patterns, which results in interference at user equipment 102 in the absence of muting. Hence, computer 100, on performing above-described acts 311-314 and 321-328, generates and transmits to base stations 101A, 101I, 101J and 101N the four muting sequences 00110011, 00001111, 10100110, 01100110 respectively, each of L=8 and D=50%.

User equipment 102 (FIG. 1A) measures, in a first positioning occasion, a time of arrival τⱼ of a PRS signal from base station 101J, because the other three base stations 101A, 101I and 101N are muted in the first positioning occasion while base station 101J is unmuted. Similarly, user equipment 102 measures, in a second positioning occasion, another time of arrival τₙ of another PRS signal from base station 101N because the other three base stations 101A, 101I and 101J are muted in the second positioning occasion while base station 101N is unmuted. Thus, user equipment 102 computes a difference between the two times of arrival, namely τₙ−τⱼ as a Reference Signal Time Difference (RSTD) measurement, which is used with two or more other such RSTD measurements to determine a location of user equipment 102.

In several embodiments described above, a computer 100 is configured to operate as both simulator 310 and muting sequence generator 320. In contrast, in other embodiments as described below, one computer 500 (FIG. 5A) is configured to operate as simulator 310 by performing acts 311-314 (FIG. 3A), and additional computers 510 (FIG. 5B) of base stations 251A, 251I, 251J, 251N are configured to operate as a muting sequence generator 320 to prepare muting sequences by each performing acts 321-328 (FIG. 3A). In some embodiments, a single computer 340 is configured to perform acts 341-344 (FIG. 3B) in a manner similar or identical to corresponding acts 311-314 (FIG. 3A) described above, followed by acts 345-348 (FIG. 3B). Acts 345, 346 and 347 are similar or identical to corresponding acts 324, 325 and 326 (FIG. 3A) described above, except for the following differences. More specifically, computer 340 goes to act 348 as follows: (1) when the answer is no in act 345, (2) when the answer is yes in act 346, and (3) on completion of act 347. Act 348 is performed repeatedly for each PCI, to transmit to each base station 251I, a duty cycle and a length (described above), for use in sequence generation by base station 251I. Transmission of a duty cycle of 50%, a length of 8 from computer 200 to base stations 251A . . . 251I . . . 251J . . . 251N is illustrated in FIG. 2A.

Hence in the just-described embodiments, each base station 251I receives the duty cycle and length in an act 351 (FIG. 3C). Then, each base station 251I performs an act 352 (FIG. 3C) by using its own PCI to determine a table index, in a manner similar or identical to a corresponding act 322 (FIG. 3A) described above. Thereafter, in an act 323, each base station 251I uses the table index in performing a common procedure, to prepare a sequence having the length and duty cycle received in act 321, in a manner similar to generation of a particular sequence in act 321 (described above), at a specific iteration in act 321 identified by the table index. More specifically, in act 353, base station 251I executes a common procedure of the type illustrated in FIG. 4A to generate a particular sequence of binary values of the length and duty cycle received in act 351. Subsequently, each base station 251A, 251I, 251J, 251N performs an act 354 (FIG. 3C) in a manner similar or identical to act 324 (FIG. 3A). If the answer in act 354 is yes, then each base station 251I performs an act 357 similar or identical to act 327 (FIG. 3A), and then performs act 358. If the answer in act 354 is no, then each base station 251I performs act 358. In act 358, each base station 251I transmits a PRS signal muted as per the specified sequence (obtained in act 357 or in act 353, which depends on act 354). Transmission of PRS signals muted by the base stations 251A . . . 251I . . . 251J . . . 251N is illustrated in FIG. 2A.

In certain embodiments of the type described above in reference to FIG. 2A, in the above-described common procedure, when executed by base station 251I, a processor 516 (FIG. 5B) receives as inputs (1) length L of a sequence to be generated, (2) duty cycle expressed as a fraction, and (3) table index derived from PCI, and uses these three inputs to generate the sequence. In some embodiments, execution of the common procedure may enumerate or randomly identify positions of n binary ones in a vector of length L (initialized to binary zeros), wherein n=L*duty cycle. Other embodiments of the common procedure may be implemented (e.g. by computer 500 of a location server) as summarized below, and further described in detail in reference to acts 431-447 (FIG. 4A). The total number Ns of unique muting sequences that may be generated by execution of the common procedure is Ns=L!/[(L−L*duty cycle)!*(L*duty cycle)!].

Some embodiments of the common procedure assume an ordering of muting sequences in a decreasing order of corresponding decimal values (of the respective muting sequences). Execution of the common procedure determines a muting sequence that appears in this assumed order, at a location specified by the third input, namely table index. A muting sequence, in binary, of length L has N1=L*duty cycle number of is (binary ones), and N0 number of 0s (binary zeros). For example, if the first input, namely length L is 8 and if the second input, namely duty cycle is 50% (as shown in FIG. 2A), then there will be 4 binary ones and 4 binary zeros, in each muting sequence that is generated by execution of the common procedure.

During execution of the common procedure, processor 506 and/or 516 (FIGS. 5A, 5B) determines a location of each of N1 binary ones in a vector z initialized to binary zeros (e.g. in act 433 in FIG. 4A), by executing N1 loops wherein the vector is overwritten with the binary ones, and output as sequence z. In each of these N1 loops, processor 506 and/or 516 (FIGS. 5A, 5B) determines a next location of a binary one “1” in a particular sequence z, relative to a previous location of another binary one “1” in the particular sequence z (or relative to a first location, initially). More specifically, in an i-th loop (e.g. implemented by acts 437-446 shown in FIG. 4A), processor 506 and/or 516 (FIGS. 5A, 5B) uses a count of sequences that have been generated at every successive choice of location of the i-th binary one “1” and comparing against a looping index (e.g. in act 439 in FIG. 4A), determines the location of the i-th binary one “1” in sequence z (e.g. in act 442 or in act 444) by checking that the value of the looping index (e.g. rem in FIG. 4A) is less than a sum of counts of sequences (e.g. Sν in FIG. 4A), for choices of possible locations of the i-th binary “1” (in sequences of length <L). The just-described checking may be done, e.g. in acts 439 and 440 in FIG. 4A as described below.

Specifically, in act 439 in FIG. 4A, the value of rem is checked against an initial sum of sequence counts, namely Sν(1). If the result is that rem is greater in act 439, then this rem value is further checked in act 440 against one or more values of the sequence counts sum Sν(j) based on corresponding values of j (in the range 1 to L-e-r+2) to determine a maximum value of j for which the looping index rem is greater than Sν(j). Then, jmax is used in act 441 to decrement the looping index rem by a count sum, e.g. at the jmax location in the sequence counts sum Sν(jmax). Note that the looping index's value rem is initialized to the third input, namely the table index which is derived from PCI (e.g. index in act 434 in FIG. 4A), at the beginning of the N1 loops. Act 441 is followed by assigning (e.g. in act 442) to the ith row in an integer locations table e.g. TableEntry(i), a sum of jmax and the location (e.g. e in FIG. 4A) of the ith binary one (“1”).

The integer locations table TableEntry is a table of integer locations of binary ones in a sequence z. Then, in an act 443, the location (e.g. e in FIG. 4A) of the ith binary one (“1”), namely e is set to the value of the ith element, in the integer locations table TableEntry. If the result is that rem is less in act 439, then in act 444 the just-described location (e.g. e in FIG. 4A) of the ith one (“1”) is assigned to the ith row, in the integer locations table TableEntry(i). After act 444, act 443 is also performed, namely e is set to the value of the ith element, in the integer locations table TableEntry.

After act 443, the value of r is decremented in act 445, and the value of i is incremented in act 446, followed by returning to act 437. In act 446, when the value of i reaches the value of a local variable ro (initialized to the number of binary ones “1s” to be generated in act 432), the looping may be stopped, by performing act 447. In act 447, vector z (which was initialized to binary zeros in act 433) may be overwritten with binary ones at the integer locations specified in the table TableEntry, and the overwritten vector may be supplied (e.g. in act 447 of FIG. 4A), as a generated sequence z, which completes execution of the common procedure. This common procedure is now described in further detail, below.

In several embodiments, processor 506 and/or 516 (FIGS. 5A, 5B) receives the above-described three inputs in an act 431 (FIG. 4A) followed by an act 432 wherein processor 506 and/or 516 (FIGS. 5A, 5B) sets a local variable ro to length L multiplied by duty cycle in an act 432. As noted above, in an act 433 in the common procedure, processor 506 and/or 516 (FIGS. 5A, 5B) initializes each element in vector z of length L to the binary value 0. Also as noted above, in an act 434, processor 506 and/or 516 (FIGS. 5A, 5B) initializes another local variable rem to the table index. Furthermore, in an act 435, local variables e and r are initialized by processor 506 and/or 516 (FIGS. 5A, 5B) to the value 1 (integer one), and the value of variable ro respectively. Additionally, in an act 436, a variable i (used to index into the integer locations table TableEntry) is initialized by processor 506 and/or 516 (FIGS. 5A, 5B) to value 1 (integer one). Acts 432 to 436 described above can be performed in any order relative to one another, depending on the embodiment.

After initialization in acts 432-436, processor 506 and/or 516 (FIGS. 5A, 5B) enters a loop to perform acts 437-445, incrementing variable i by 1 in act 446 and returning to act 437 until i exceeds the value ro at which time, processor 506 and/or 516 (FIGS. 5A, 5B) exits the loop to perform act 447, as described below. On entering the loop, in an act 437 processor 506 and/or 516 (FIGS. 5A, 5B) computes one or more elements of a vector ν(j) as follows:

$$v ( j ) = \frac{( L - e - j + 1 ) !}{( L - e - j + 2 - r ) ! ( r - 1 ) !}$$

$$for$$

$$j = 1$$

$$to$$

$$L - e - r + 2$$

For example, if length L is 4, duty cycle D is 50%, index is 3, ro is 2, rem is 3, e is 1 and r is 2, then j ranges from 1 to 3, and hence, vector ν has three elements. Moreover, in an act 438, processor 506 and/or 516 (FIGS. 5A, 5B) computes sequence counts sum Sν(j) as follows:

Sν(j)=ν(1)+ . . . +ν(j) f or j=1 to L−e−r+2

Thus, in the above-described example, sequence counts sum Sνalso has three elements. After computing the two vectors ν and Sν, processor 506 and/or 516 (FIGS. 5A, 5B) checks, in act 439, whether the variable rem is greater than the first element in the vector Sν. Note that variable rem is initialized by processor 506 and/or 516 (FIGS. 5A, 5B) in act 434 to index and decremented by processor 506 and/or 516 (FIGS. 5A, 5B) in an act 441 (described below).

In act 439, if the answer is yes, then processor 506 and/or 516 (FIGS. 5A, 5B) performs an act 440 to identify a largest value of index j in vector Sν such that the value of variable rem is greater than Sν(j), and this largest value of index j is stored in a variable jmax. After performing act 440, processor 506 and/or 516 (FIGS. 5A, 5B) performs an act 441 to decrement the variable rem by the value of the jmaxth element of Sν, followed by act 442. In act 442, processor 506 and/or 516 (FIGS. 5A, 5B) initializes an element identified by looping variable i in vector TableEntry to the value e+jmax, followed by act 443. In act 443, processor 506 and/or 516 (FIGS. 5A, 5B) sets the variable e to the ith element in vector TableEntry, followed by act 445 in which r is decremented by 1, followed by act 446 (described above). In act 439, if the answer is no, then processor 506 and/or 516 (FIGS. 5A, 5B) performs act 444 in which the ith element in vector TableEntry is set to the value of variable e, followed by act 443 in turn followed by act 445 (both described above), and then performs act 446 (described above). As noted above, in act 446 if the value of i exceeds the value of variable ro, processor 506 and/or 516 (FIGS. 5A, 5B) exits the loop and goes to act 447. In act 447, processor 506 and/or 516 (FIGS. 5A, 5B) sets elements (e.g. binary values) of vector z that are indexed by an element of vector TableEntry to 1, and outputs the vector z for use as a muting sequence. In the above-described example, if the vector TableEntry has integer values [0, 2, 3], then vector z is set to the binary values [1011], which is used as a muting sequence of length 4.

In several aspects of the described embodiments, a processor 506 and/or 516 (FIGS. 5A, 5B) is used to enumerate all sequences of bits that have a specified length L and a specified duty cycle D as described above. In some embodiments, processor 506 (of base stations 101I, 251I) is coupled to downlink transmitter 502 to turn it off when a positioning occasion is identified in a muting sequence with the binary value 0 and to turn it on when the positioning occasion is identified in the muting sequence with binary value 1.

Either of processors 506 or 516 (FIGS. 5A, 5B) may include an arithmetic logic unit (ALU) which is programmed (or configured in hardware) to operate as an enumerator of sequences of length L and duty cycle D, by execution of instructions in memory 505 or 515 respectively. Memories 505 and 515 are coupled to respective processors 506 and 516 (FIGS. 5A, 5B) to receive and store one or more muting sequences, e.g. in a table. Thereafter each muting sequence may be used by a computer 510 (FIG. 5B) of a base station (of corresponding identity PCI) to transmit a corresponding PRS signal via downlink transmitter 512 and antenna 511. The muting sequences may be received by processor 516 in a computer 510 of a base station, in some embodiments via LAN circuit 514 that is coupled to a cable 518 (formed of copper or optical fiber).

Depending on the aspect of the described embodiments, a user equipment (UE) of the type described above, configured to measure times of arrival of PRS signals from multiple base stations, may be included in any mobile station (MS), of the type described herein. As used herein, a mobile station (MS) refers to a device such as a cellular or other wireless communication device (e.g. cell phone), personal communication system (PCS) device, personal navigation device (PND), Personal Information Manager (PIM), Personal Digital Assistant (PDA), laptop or other suitable mobile device which is capable of receiving wireless communications. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND.

Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server computer, or at another device associated with the network. Any operable combination of the above are also considered a “mobile station.” The terms “mobile station” and “mobile device” are often used interchangeably. Personal Information Managers (PIMs) and Personal Digital Assistants (PDAs) which are capable of receiving wireless communications. Note that in some aspects of the described embodiments, such a mobile station is equipped with a network listening module (NLM) configured to use PRS signals to perform TOA measurements that are then transmitted to a location computer (not shown).

The methodologies described herein in reference to any one or more of FIGS. 1A, 1B, 2A, 2B, 3A-3C, 4A-4C and 6 may be implemented by various means depending upon the application. For example, these methodologies may be implemented in hardware, firmware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any non-transitory machine readable medium tangibly embodying instructions (e.g. in binary) may be used in implementing the methodologies described herein. For example, computer instructions (in the form of software) may be stored in a memory 505 or 515 (FIGS. 5A, 5B) of a computer 500 or 510, and executed by a processor 506 or 516, for example a microprocessor. The just-described computer can be computer 100, 200 (FIGS. 1A, 2A) configured to perform OA & M functions, or a computer in base stations 101I, 251I configured to perform base station functions. Memory 505, 515 (FIGS. 5A, 5B) may be implemented within a single chip that includes processor 506, 516 or external to the chip that contains processor 506, 516. As used herein the term “memory” refers to any type of long term, short term, volatile (e.g. DRAM), nonvolatile (e.g. SRAM), or other memory accessible by processor 306, and is not to be limited to any particular type of memory or number of memories, or type of media upon which memory is stored.

Processor 506, 516 configured to execute first instructions in memory 505, 515 may, in some embodiments, be used to implement means for automatically generating N sequences of binary values based on a specific length and a specific duty cycle. Moreover, processor 506, 516 configured to execute second instructions in memory 505, 515 may, in such embodiments, be used to implement means, responsive to an identity of a cell, to select a sequence in the N sequences for use in transmission of a positioning signal. In some embodiments (“direct-usage embodiments”), the selected sequence is eventually transmitted via antenna 511 of a base station, e.g. by muting a positioning signal in one subset of positioning occasions identified by a first binary value in the selected sequence and normal transmission (without muting) in another subset of positioning occasions identified by a second binary value in the selected sequence. In certain embodiments (“indirect-usage embodiments”), the selected sequence is used as a generator sequence, by processor 306 configured to execute third instructions in memory 305, which may for example, implement means for elongating the generator sequence in a predetermined way to obtain an elongated sequence. The elongated sequence is eventually transmitted via antenna 301 of a base station, in these embodiments (“indirect-usage embodiments”), e.g. by muting a positioning signal in one subset of positioning occasions identified by a first binary value in the elongated sequence and normal transmission (without muting) in another subset of positioning occasions identified by a second binary value in the elongated sequence.

A user equipment (UE) 102 (FIG. 1A), such as any mobile device or mobile station, may itself include one or more processors and one or more memories, similar to computer 100, 200, or a computer in base stations 101I, 251I illustrated in FIGS. 1A, 2A. Such processor(s) (in UE 102) in may be programmed with instructions comprised in non-transitory computer-readable storage media, to prepare and transmit TOA and/or TDOA measurements, in response to requests from a location computer (not shown). Hence, a memory (in DE 102) may include machine instructions to its processor to use measurements of arrival times to compute time difference of arrival values (also called TDOA measurements). On execution of instructions in memory by a processor (in UE 102), each TDOA measurement may be computed as a difference between a pair of measurements, among TOA measurements in memory of UE 102.

A computer 510 in a base station and/or computer 500 configured to perform OA&M functions, may be programmed in some indirect-usage embodiments, to implement a muting sequence elongator 450 that elongates a sequence (called “generator muting sequence”) using a matrix, in a method that includes acts 451-461 (FIG. 4A), as follows. In act 451, computer 500 and/or 510 reads from memory, a generator muting sequence having length L1, which may be a highest ranked muting sequence stored in memory, e.g. by act 314 of FIG. 3A. In act 452, computer 500 and/or 510 reads from memory, a value of transmit diversity length L2 at base stations that are to use the generator muting sequence. Transmit diversity length L2 may indicate, for example, a number of transmitters which use wavelengths at least ¼^{th}wavelength apart from one another, and/or a number of different transmit properties (e.g. phase shift), and/or a number of paths. In act 453, computer 500 and/or 510 checks whether a product of L1 and L2 is greater than the predetermined maximum Lmax, which may be a limit on length of a muting sequence, as defined in an industry standard (e.g. 16).

If the answer is no in act 453, computer 500 and/or 510 performs acts 457-461 as follows. In act 457, computer 500 and/or 510 allocates memory for a matrix MPTX having L2 rows and L1 columns. For example, if transmit diversity length L2 is 4 and length L1 of generator muting sequence is 2, then a matrix MPTX of 4 rows and 2 columns is set up in act 457. Also in act 457, computer 500 and/or 510 initializes a looping variable numTxAssigned to zero. Looping variable numTxAssigned is used by computer 500 and/or 510 to iteratively fill matrix MPTX. Specifically, in act 458, computer 500 and/or 510 checks whether numTxAssigned is equal to transmit diversity length L2, and if not this variable numTxAssigned is incremented in act 459, followed by act 460. In act 460, computer 500 and/or 510 obtains a permuted sequence, by use of the generator muting sequence read from memory in act 451. In a default embodiment, computer 500 and/or 510 is configured to use in act 460, the generator muting sequence of act 451 with no change therein, as the permuted sequence. In another embodiment, binary values in the generator muting sequence are re-shuffled in a predetermined manner in act 460, to form a permutation thereof, which is used as the permuted sequence.

A permuted sequence may be prepared in act 440 of some embodiments from a generator muting sequence (GMS) of length L1 by use of a random number generator, as follows:

OriginalGMS=GMS,

PermutedGMS=empty vector,

for i=1 to L1:
use a random generator to pick an element (e.g. binary value) of OriginalGMS,
assign the value of this element to the i-th position of PermutedGMS,

and
remove this element from the OriginalGMS

endfor

A permuted sequence which has been prepared in act 460 is thereafter stored in act 461, in matrix MPTX, in a row which is identified by looping variable numTxAssigned. Thereafter, computer 500 and/or 510 returns to act 458 (described above). When a result of checking in act 458 is yes, computer 500 and/or 510 goes to act 456 to output a sequence, by reading the matrix MPTX one column at a time. Specifically, in act 456, column [0] is read out from matrix MPTX, followed by column [1] and so on, until all L1 columns of matrix MPTX are read. Thus a sequence of length L1×L2 is output by act 456, and in an act 462 this sequence is used by one or more base stations, to transmit a positioning signal that is muted in specific occasions, as identified by a specific binary value (e.g. value 0) in the muting sequence.

In act 453, if the answer is yes, certain embodiments of computer 500 and/or 510 are configured to perform act 454 as described next, to store a sequence in a row of the matrix MPTX, and thereafter act 456 is performed as described above, followed by act 462 wherein PRS is transmitted as per the muting sequence output by act 456. In some embodiments of act 454, computer 500 and/or 510 obtains the sequence, by permutation of the generator muting sequence (which was read from memory in act 451), in a manner similar or identical to act 460 (described above). In another embodiment of act 454, computer 500 and/or 510 is configured to use the generator muting sequence of act 451 with no change therein, which is directly stored in a row of matrix MPTX. In other embodiments of act 454, computer 500 and/or 510 is configured to obtain a sequence to be stored in the row of matrix MPTX by performing the above-described act 327 (FIG. 3A), e.g. when length L1 of the generator muting sequence is less than the predetermined maximum Lmax.

In a first illustrative example, a generator muting sequence is of length 2 (hence L1=2), and transmit diversity is 4 (hence L2=4). The generator muting sequence of this example may be represented as AB, wherein A is a binary value e.g. 0 or 1 and B is another binary value, e.g. 0 or 1. In this example, the following values are stored in matrix MPTX when the yes branch is taken out of act 458 (e.g. on performance of acts 460 and 461 which are repeated 4 times, once for each transmitter):

| | |
|---|---|
| A | B |
| A | B |
| A | B |
| A | B |

In the above example, act 460 is implemented in a default mode, to repeatedly return the generator muting sequence itself (e.g. AB), for use as a permutation thereof. Accordingly, when the MPTX matrix is read out column-wise in act 456, the muting sequence that is output (for use in PRS transmission in act 462) is AAAABBBB, which supports transmit diversity, as confirmed by performance of method 470 (FIG. 4C), described below.

In a second illustrative example, act 460 is implemented to return the generator muting sequence itself (e.g. AB) three times followed by returning BA as the permutation thereof. Hence, the following values are stored in matrix MPTX

| | |
|---|---|
| A | B |
| A | B |
| A | B |
| B | A |

Accordingly, when the MPTX matrix is read out column-wise in act 456, the muting sequence that is output (for use in PRS transmission in act 462) is AAABBBBA, which also supports transmit diversity, as confirmed by performance of method 470 (FIG. 4C), described below.

In a third illustrative example, act 460 is implemented to return the generator muting sequence itself (e.g. AB) two times followed by returning BA as the permutation thereof, followed by returning the generator muting sequence itself once again. Hence, the following values are stored in matrix MPTX

| | |
|---|---|
| A | B |
| A | B |
| B | A |
| A | B |

Accordingly, when the MPTX matrix is read out column-wise in act 456, the muting sequence that is output (for use in PRS transmission in act 462) is AABABBAB, which also supports transmit diversity, as confirmed by performance of method 470 (FIG. 4C), described below.

In a fourth illustrative example, act 460 is implemented to return the generator muting sequence itself (e.g. AB) two times followed by returning BA as the permutation thereof two times. Hence, the following values are stored in matrix MPTX

| | |
|---|---|
| A | B |
| A | B |
| B | A |
| B | A |

Accordingly, when the MPTX matrix is read out column-wise in act 456, the muting sequence that is output (for use in PRS transmission in act 462) is AABBBBAA, which also supports transmit diversity, as confirmed by performance of method 470 (FIG. 4C), described below.

In a fifth illustrative example, act 460 is implemented to return the generator muting sequence itself (e.g. AB) once followed by returning BA as the permutation thereof once, followed by returning the generator muting sequence itself (e.g. AB) twice. Hence, the following values are stored in matrix MPTX

| | |
|---|---|
| A | B |
| B | A |
| A | B |
| A | B |

Accordingly, when the MPTX matrix is read out column-wise in act 456, the muting sequence that is output (for use in PRS transmission in act 462) is ABAABABB, which also supports transmit diversity, as confirmed by performance of method 470 (FIG. 4C), described below.

In a sixth illustrative example, act 460 is implemented to return the generator muting sequence itself (e.g. AB) once followed by returning BA as the permutation thereof once, followed by returning the generator muting sequence itself (e.g. AB) once, followed by returning BA as the permutation thereof once again. Hence, the following values are stored in matrix MPTX

| | |
|---|---|
| A | B |
| B | A |
| A | B |
| B | A |

Accordingly, when the MPTX matrix is read out column-wise in act 456, the muting sequence that is output (for use in PRS transmission in act 462) is ABABBABA, which also supports transmit diversity, as confirmed by performance of method 470 (FIG. 4C), described below.

In a seventh illustrative example, act 460 is implemented to return the generator muting sequence itself (e.g. AB) once followed by returning BA as the permutation thereof two times, followed by returning the generator muting sequence itself (e.g. AB) once again. Hence, the following values are stored in matrix MPTX

| | |
|---|---|
| A | B |
| B | A |
| B | A |
| A | B |

Accordingly, when the MPTX matrix is read out column-wise in act 456, the muting sequence that is output (for use in PRS transmission in act 462) is ABBABAAB, which also supports transmit diversity, as confirmed by performance of method 470 (FIG. 4C), described below.

In an eighth illustrative example, act 460 is implemented to return the generator muting sequence itself (e.g. AB) once followed by returning BA as the permutation thereof three times. Hence, the following values are stored in matrix MPTX

| | |
|---|---|
| A | B |
| B | A |
| B | A |
| B | A |

Accordingly, when the MPTX matrix is read out column-wise in act 456, the muting sequence that is output (for use in PRS transmission in act 462) is ABBBAAA, which also supports transmit diversity, as confirmed by performance of method 470 (FIG. 4C), described below.

Note that although only eight illustrative examples are described above, another eight such examples will be readily apparent wherein act 440 is implemented opposite to the above-described implementation (e.g. in an opposite of the first illustrative example the permutation BA is returned all four times, and in an opposite of the second illustrative example, the permutation BA is returned three times followed by return of the generator muting sequence itself once). Accordingly, numerous such examples will be apparent to the skilled artisan, in view of this detailed description.

In some embodiments, computer 500, 510 (FIGS. 5A, 5B) may be configured to perform a method 470 (FIG. 4C) after acts 431 and 432 (FIG. 4A), to check whether all transmitters are used, in transmitting a PRS signal when a muting sequence is applied thereto. Method 470 (FIG. 4C) can be performed before act 433 to check the generator muting sequence of act 431 and/or method 470 (FIG. 4C) can be performed after act 436 to check the muting sequence created by use of matrix MPTX, before transmission of PRS in act 442.

In act 473 of method 470, computer 500, 510 (FIGS. 5A, 5B) allocates memory for a one dimensional vector txCovered having at least L2 binary valued elements, i.e. vector txCovered has length L2 and is initialized to the binary value 0. Each element in vector txCovered corresponds to a transmitter in a base station, and the binary value 0 indicates that the corresponding transmitter is not being used (in transmitting a PRS signal when the muting sequence is applied thereto). In act 473, computer 500, 510 (FIGS. 5A, 5B) also sets a looping variable numMPCount to zero. Variable numMPCount indicates a number of iterations performed in an outer loop over the muting sequence, wherein acts 478, 479 and 480 are performed repeatedly, once for each bit in the muting sequence. Hence in act 474, computer 500, 510 (FIGS. 5A, 5B) checks whether numMPCount is equal to length L1 of the muting sequence, and if not goes to act 478.

In act 478, computer 500, 510 (FIGS. 5A, 5B) sets another looping variable txCount to zero. Variable txCount indicates a number of transmitters that are checked in an inner loop, wherein acts 511, 512 and 514 are performed repeatedly, once for each transmitter. Hence in act 479 (FIG. 4C), computer 500, 510 (FIGS. 5A, 5B) checks whether txCount is equal to L2 (which is the number of transmitters), and if so goes to act 480 and if not goes to act 481. In act 481 (FIG. 4C), computer 500, 510 increments numMPCount by 1, and then returns to act 474 (described above). In act 481 (FIG. 4C), computer 500, 510 initializes a local variable myIndex (which identifies a specific transmitter among all transmitters in a base station) to mod (txCount, L1)+1, and goes to act 482. In act 482, computer 500, 510 checks whether a binary value is 1 in the muting sequence at the location identified by myIndex (which indicates whether the specific transmitter is turned on), and if so goes to act 483 and sets a corresponding element (e.g. binary value) in vector txCovered identified by txCount to 1 and then goes to act 484. If the answer in act 482 is no, then computer 500, 510 goes directly to act 484 (i.e. act 483 is skipped, so that the corresponding element in vector txCovered identified by txCount remains unchanged at the originally-initialized binary value of 0). In act 484, computer 500, 510 increments txCount by 1 and then returns to act 479 (described above).

In act 474, when the answer is yes, computer 500, 510 goes to act 475 wherein it sums up the number of binary 1s in vector txCovered, and checks whether this sum is equal to L2, and if yes then in act 476 computer 500, 510 generates a signal, indicating that the muting sequence and the transmit diversity (which were read from memory in acts 471 and 472) are compatible (in which case acts 473-481 may be skipped), and the muting sequence is used directly (with no change) in transmitting PRS as per act 462 (FIG. 4B), in direct-usage embodiments. If the answer in act 475 is no, then computer 500, 510 goes to act 477 and generates another signal, indicating transmit diversity is not fully exercised (in which case acts 473-481 are performed, to elongate the muting sequence) in indirect-usage embodiments, followed by act 462 as described above (FIG. 4B).

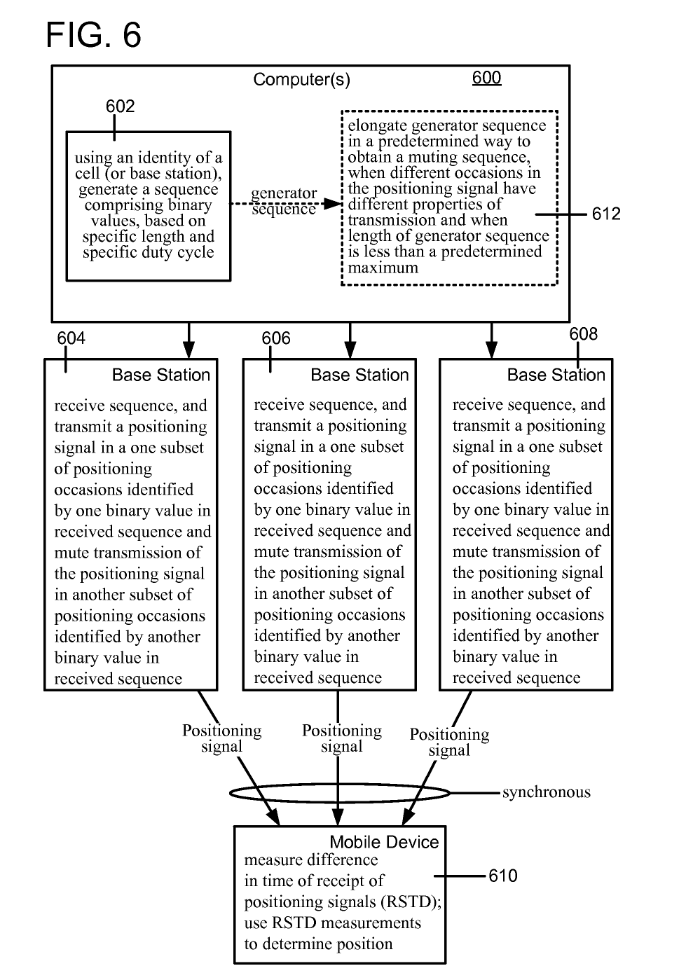

In some embodiments, as illustrated in FIG. 6, one or more computer(s) 600 use an identity of a cell (or base station) to automatically generate a sequence comprising binary values, based on a specific length and a specific duty cycle. Each sequence is transmitted by the one or more computer(s) 600 to a corresponding base station which has the identity (which was used in generating the sequence), such as one of base stations 604, 606 and 608. Base station 604 uses a sequence received from computer(s) 600 to transmit a positioning signal in a first subset of positioning occasions identified by a first binary value in the sequence, and muting transmission of the positioning signal in a second subset of positioning occasions identified by a second binary value in the sequence.

As illustrated in FIG. 6, a second base station 606 has a second identity, which is different from the identity (hereinafter first identity) of base station 604 (hereinafter first base station 604). Thus, second base station 606 receives a second sequence, which is different from the sequence received by base station 604 (hereinafter first sequence). The second sequence may be generated (e.g. by computer(s) 600 in act 602, as noted above), based on the same specific length and the same specific duty cycle as the first sequence. Thus, the second base station 606 transmits a second positioning signal, which is muted as per the second sequence. The second positioning signal may be transmitted by the second base station 606 synchronously relative to the positioning signal (hereinafter first positioning signal) transmitted by the first base station 604.

In a similar manner, a third base station 608 which has a third identity may receive a third sequence that may also be generated based on the same specific length and the same specific duty cycle as the first sequence and the second sequence. Thus the third base station 608 may transmit a third positioning signal which is muted as per the third sequence. A mobile device 610 may receive and measure difference in arrival times of the just-described first, second, and third positioning signals, to obtain RSTD measurements, and use the RSTD measurements to determine its position.

Some embodiments of computer(s) 600 may be configured to use each of the above-described sequences, namely the first sequence, the second sequence and the third sequence, as a generator sequence in an act 612 (FIG. 6) to elongate the generator sequence. The generator sequence may be elongated in a predetermined way, to obtain a muting sequence, when different occasions in the positioning signal have different properties of transmission and when a first length 1 of the generator sequence is less than a predetermined maximum, the muting sequence having a second length L that is larger than the first length 1 of the generator sequence. In such embodiments, multiple transmitters are used by each of the base stations 604, 606 and 608, to transmit their respective positioning signals, with positioning occasions therein muted as per the muting sequence obtained by elongation in act 612. The predetermined way used to elongate a generator sequence in act 612 may include, individually or in any combination with one another: (a) repeating the generator sequence in reverse order, or/and (b) repeating each binary value in the generator sequence, or/and (c) obtain a permutation of the generator sequence.

If implemented in firmware and/or software, the functions may be stored as one or more instructions or code on a non-transitory computer-readable storage medium. Examples include non-transitory computer-readable storage media encoded with a data structure and non-transitory computer-readable storage media encoded with a computer program. Non-transitory computer-readable storage media may take the form of an article of manufacture. Non-transitory computer-readable storage media includes any physical computer storage media that can be accessed by a computer. By way of example, and not limitation, such non-transitory computer-readable storage media can comprise SRAM, ROM, EEPROM, CD-ROM or other optical disk storage, magnetic disk storage or other magnetic storage devices, or any other non-transitory medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to using TDOA measurements to determine location as noted above, other embodiments may use other location determination methods such as Global Positioning System (GPS), and/or various other satellite positioning systems (SPS), such as the Russian Glonass system, the European Galileo system, any system that uses satellites from a combination of satellite systems, or any satellite system developed in the future. Accordingly, although a TDOA method is used in some aspects of the described embodiments, the system and method described herein may be implemented in any positioning system.

Furthermore, some aspects of the disclosed method and apparatus may be used with positioning determination systems that utilize wireless signals from pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used in describing this described embodiments, is intended to include pseudolites, equivalents of pseudolites, and possibly others. The term “SPS signals”, as used herein, is intended to include SPS-like signals from pseudolites or equivalents of pseudolites.

Moreover, position determination techniques used by computer 100, 200, or a computer in base stations 101I, 251I (FIG. 3) may be used for various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

The described embodiments may be implemented in conjunction with Wi-Fi/WLAN or other wireless networks. In addition to Wi-Fi/WLAN signals, and positioning signals from base stations, a wireless/mobile station or mobile device may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System). The described embodiments may also be implemented in conjunction with pseudolites or a combination of systems that includes pseudolites. The described embodiments can be implemented in conjunction with femtocells or a combination of systems that includes femtocells.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

This disclosure includes example embodiments; however, other implementations can be used. Designation that something is “optimized,” “required” or other designation does not indicate that the current disclosure applies only to systems that are optimized, or systems in which the “required” elements are present (or other limitation due to other designations). These designations refer only to the particular described implementation.

Of course, many implementations of a method and system described herein are possible depending on the aspect of the described embodiments. The techniques can be used with protocols other than those discussed herein, including protocols that are in development or to be developed.

“Instructions” as referred to herein include expressions which represent one or more logical operations. For example, instructions may be “machine-readable” by being interpretable by a machine (in one or more processors) for executing one or more operations on one or more data objects. However, this is merely an example of instructions and claimed subject matter is not limited in this respect. In another example, instructions as referred to herein may relate to encoded commands which are executable by a processing circuit (or processor) having a command set which includes the encoded commands. Such an instruction may be encoded in the form of a machine language understood by the processing circuit. Again, these are merely examples of an instruction and claimed subject matter is not limited in this respect.

In several aspects of the described embodiments, a non-transitory computer-readable storage medium is capable of maintaining expressions which are perceivable by one or more machines. For example, a non-transitory computer-readable storage medium may comprise one or more storage devices for storing machine-readable instructions and/or information. Such storage devices may comprise any one of several non-transitory storage media types including, for example, magnetic, optical or semiconductor storage media. Such storage devices may also comprise any type of long term, short term, volatile or non-volatile devices memory devices. However, these are merely examples of a non-volatile computer-readable storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “locating,” “terminating,” “identifying,” “initiating,” “detecting,” “solving”, “obtaining,” “hosting,” “maintaining,” “representing,” “estimating,” “reducing,” “associating,” “receiving,” “transmitting,” “determining,” “storing” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine (or computer) readable instructions stored in a non-transitory computer-readable storage medium, for example. Such machine (or computer) readable instructions may comprise, for example, software or firmware stored in a non-transitory computer-readable storage medium included as part of a computing platform (e.g., included as part of a processing circuit or external to such a processing circuit). Further, unless specifically stated otherwise, a process described herein, with reference to flow diagrams or otherwise, may also be executed and/or controlled, in whole or in part, by such a computing platform.

Various adaptations and modifications may be made without departing from the scope of the described embodiments. Numerous modifications and adaptations of the embodiments described herein are encompassed by the attached claims.

1. A method to coordinate transmission of a plurality of positioning signals, the method comprising:
obtaining a length and a duty cycle corresponding to a plurality of positioning occasions mutable in a transmission schedule of a positioning signal;
obtaining a plurality of identities of a plurality of base stations available to transmit the plurality of positioning signals;
determining, by one or more computers, one or more muting characteristics, based at least in part on the length, the duty cycle, and at least one identity in the plurality of identities; and
transmitting the one or more muting characteristics at least to a base station identified by said at least one identity.

2. The method of claim 1 wherein:
the one or more muting characteristics comprise software;
the determining identifies the software from among one or more softwares;
the transmitting transmits the software to the base station;
execution of at least the software by the base station of said at least one identity generates a specific sequence; and
the specific sequence identifies one or more periods mutable in the positioning signal transmitted by the base station.

3. The method of claim 1 wherein:
the one or more muting characteristics comprise a set of sequences;
the determining generates at least the set of sequences;
the transmitting transmits the set of sequences to the plurality of base stations including the base station; and
in the set of sequences, a specific sequence is identifiable by an identity of the base station.

4. The method of claim 1 wherein:
the one or more muting characteristics comprise a specific sequence;
the determining generates a set of sequences including the specific sequence, and identifies the specific sequence from among the set of sequences based at least partially on an identity of the base station; and
the transmitting transmits the specific sequence to the base station.

5. The method of claim 4 wherein:
the specific sequence identifies one or more periods that are mutable in the positioning signal transmitted by the base station; and
a bit of a predetermined value in the specific sequence identifies a specific period of muting, among the one or more periods.

6. The method of claim 1 wherein:
the one or more muting characteristics comprise an elongated sequence;
the determining comprises generating a set of sequences including a specific sequence, and elongating the specific sequence in a predetermined way to ensure that un-muted occasions are equally distributed in the transmission schedule among odd positioning occasions and even positioning occasions in which two corresponding transmitters are used by the base station; and
one or more periods mutable in the positioning signal transmitted by the base station are positioning occasions identified by the elongated sequence.

7. The method of claim 6 wherein:
the predetermined way of elongating comprises at least one of:
(a) repeating said specific sequence in reverse order, to obtain a reversed sequence and concatenating the specific sequence with the reversed sequence to obtain the elongated sequence;
(b) repeating each binary value in the specific sequence, in an order of occurrence in the specific sequence, to obtain the elongated sequence; or
(c) obtaining a permutation of said specific sequence.

8. The method of claim 1 wherein:
usage by the base station, of the one or more muting characteristics to transmit the positioning signal which is muted in one or more periods of time, improves hearability over no muting, by reducing interference among the plurality of positioning signals, at least in the one or more periods of time.

9. A non-transitory computer-readable storage media comprising a plurality of instructions, which, when executed by a processor perform steps in a method of coordinating transmission of a plurality of positioning signals, the plurality of instructions comprising:
first instructions to obtain a length and a duty cycle corresponding to a plurality of positioning occasions mutable in a transmission schedule of a positioning signal;
second instructions to obtain a plurality of identities of a plurality of base stations available to transmit the plurality of positioning signals;
third instructions to determine, one or more muting characteristics, based at least in part on the length, the duty cycle, and at least one identity in the plurality of identities; and
fourth instructions to transmit the one or more muting characteristics at least to a base station identified by said at least one identity.

10. The non-transitory computer-readable storage media of claim 9 wherein:
the one or more muting characteristics comprise software;
the software is identified from among one or more softwares, by execution of the third instructions;
the software is transmitted to the base station, by execution of the fourth instructions;
execution of at least the software by the base station of said at least one identity generates a specific sequence; and
the specific sequence identifies one or more periods mutable in the positioning signal transmitted by the base station.

11. The non-transitory computer-readable storage media of claim 9 wherein:
the one or more muting characteristics comprise a set of sequences;
the set of sequences are generated, by execution of the third instructions;
the set of sequences are transmitted to the plurality of base stations including the base station, by execution of the fourth instructions;
in the set of sequences, a specific sequence is identifiable by an identity of the base station.

12. The non-transitory computer-readable storage media of claim 9 wherein:
the one or more muting characteristics comprise a specific sequence;
a set of sequences including the specific sequence are generated, by execution of the third instructions;
the specific sequence is identified from among the set of sequences based at least partially on an identity of the base station, by execution of the third instructions; and
the specific sequence is transmitted to the base station, by execution of the fourth instructions.

13. The non-transitory computer-readable storage media of claim 12 wherein:
the specific sequence identifies one or more periods that are mutable in the positioning signal transmitted by the base station; and
a bit of a predetermined value in the specific sequence identifies a specific period of muting, among the one or more periods.

14. The non-transitory computer-readable storage media of claim 12 wherein:
the one or more muting characteristics comprise an elongated sequence;
a set of sequences including a specific sequence are generated, by execution of the third instructions;
the specific sequence is elongated in a predetermined way to ensure that un-muted occasions are equally distributed in the transmission schedule among odd positioning occasions and even positioning occasions in which two corresponding transmitters are used by the base station, by execution of the third instructions; and
one or more periods mutable in the positioning signal transmitted by the base station are positioning occasions identified by the elongated sequence.

15. The non-transitory computer-readable storage media of claim 14 wherein:
the predetermined way of elongating comprises one of:
(a) repeating said specific sequence in reverse order, to obtain a reversed sequence and concatenating the specific sequence with the reversed sequence to obtain the elongated sequence;
(b) repeating each binary value in the specific sequence, in an order of occurrence in the specific sequence, to obtain the elongated sequence; or
(c) obtaining a permutation of said specific sequence.

16. A device comprising:
a wireless transceiver;
a memory;
a processor operatively connected to the memory to execute a plurality of instructions stored in the memory, configured to:
obtain a length and a duty cycle corresponding to a plurality of positioning occasions mutable in a transmission schedule of a positioning signal;
obtain a plurality of identities of a plurality of base stations available to transmit a plurality of positioning signals;
determine, one or more muting characteristics, based at least in part on the length, the duty cycle, and at least one identity in the plurality of identities; and
use the wireless transceiver to transmit the one or more muting characteristics at least to a base station identified by said at least one identity.

17. The device of claim 16 wherein
the one or more muting characteristics comprise software;
the processor is configured to identify the software from among one or more softwares;
the processor is configured to transmit the software to the base station;
execution of at least the software by the base station of said at least one identity generates a specific sequence; and
the specific sequence identifies one or more periods mutable in the positioning signal transmitted by the base station.

18. The device of claim 16 wherein
the one or more muting characteristics comprise a set of sequences;
the processor is configured to generate at least the set of sequences;
the processor is configured to transmit the set of sequences to the plurality of base stations including the base station; and
in the set of sequences, a specific sequence is identifiable by an identity of the base station.

19. The device of claim 16 wherein
the one or more muting characteristics comprise a specific sequence;
the processor is configured to generate a set of sequences including the specific sequence, and identify the specific sequence from among the set of sequences based at least partially on an identity of the base station; and
the processor is configured to transmit the specific sequence to the base station.

20. The device of claim 19 wherein
the specific sequence identifies one or more periods that are mutable in the positioning signal transmitted by the base station; and
a bit of a predetermined value in the specific sequence identifies a specific period of muting, among the one or more periods.

21. The device of claim 16 wherein
the one or more muting characteristics comprise an elongated sequence;
the processor is configured to generate a set of sequences including a specific sequence, and elongate the specific sequence in a predetermined way to ensure that un-muted occasions are equally distributed in the transmission schedule among odd positioning occasions and even positioning occasions in which two corresponding transmitters are used by the base station; and
one or more periods mutable in the positioning signal transmitted by the base station are positioning occasions identified by the elongated sequence.

22. The device of claim 21 wherein
the predetermined way of elongating comprises one of:
(a) repeating said specific sequence in reverse order, to obtain a reversed sequence and concatenating the specific sequence with the reversed sequence to obtain the elongated sequence;
(b) repeating each binary value in the specific sequence, in an order of occurrence in the specific sequence, to obtain the elongated sequence; or
(c) obtaining a permutation of said specific sequence.

23. An apparatus for coordinating transmission of a plurality of positioning signals, the apparatus comprising:
means for obtaining a length and a duty cycle corresponding to a plurality of positioning occasions mutable in a transmission schedule of a positioning signal;
means for obtaining a plurality of identities of a plurality of base stations available to transmit the plurality of positioning signals;
means for determining one or more muting characteristics, based at least in part on the length, the duty cycle, and at least one identity in the plurality of identities; and
means for transmitting the one or more muting characteristics at least to a base station identified by said at least one identity.

24. The apparatus of claim 23 wherein:
the one or more muting characteristics comprise software;
the means for determining identifies the software from among one or more softwares;
the means for transmitting transmits the software to the base station;
execution of at least the software by the base station of said at least one identity generates a specific sequence; and
the specific sequence identifies one or more periods mutable in the positioning signal transmitted by the base station.

25. The apparatus of claim 23 wherein:
the one or more muting characteristics comprise a set of sequences;
the means for determining generates at least the set of sequences;
the means for transmitting transmits the set of sequences to the plurality of base stations including the base station; and
in the set of sequences, a specific sequence is identifiable by an identity of the base station.

26. The apparatus of claim 23 wherein:
the one or more muting characteristics comprise a specific sequence;
the means for determining generates a set of sequences including the specific sequence, and identifies the specific sequence from among the set of sequences based at least partially on an identity of the base station; and
the means for transmitting transmits the specific sequence to the base station.

27. The apparatus of claim 26 wherein:
the specific sequence identifies one or more periods that are mutable in the positioning signal transmitted by the base station; and
a bit of a predetermined value in the specific sequence identifies a specific period of muting, among the one or more periods.

28. The apparatus of claim 23 wherein:
the one or more muting characteristics comprise an elongated sequence;
the means for determining comprises means for generating a set of sequences including a specific sequence, and means for elongating the specific sequence in a predetermined way to ensure that un-muted occasions are equally distributed in the transmission schedule among odd positioning occasions and even positioning occasions in which two corresponding transmitters are used by the base station; and
one or more periods mutable in the positioning signal transmitted by the base station are positioning occasions identified by the elongated sequence.

29. The apparatus of claim 28 wherein the means for elongating the specific sequence is configured to:
(a) repeat said specific sequence in reverse order, to obtain a reversed sequence and concatenating the specific sequence with the reversed sequence to obtain the elongated sequence;
(b) repeat each binary value in the specific sequence, in an order of occurrence in the specific sequence, to obtain the elongated sequence; or
(c) obtain a permutation of said specific sequence.

30. The apparatus of claim 23 wherein:
usage by the base station, of the one or more muting characteristics to transmit the positioning signal which is muted in one or more periods of time, improves hearability over no muting, by reducing interference among the plurality of positioning signals, at least in the one or more periods of time.
